(19) United States
(12) Patent Application Publication
(10) Pub. No.: US 2025/0038630 A1
(43) Pub. Date: Jan. 30, 2025

(54) METHOD FOR MANUFACTURING FIELD MAGNET DEVICE

(71) Applicant: DENSO CORPORATION, Kariya-city (JP)

(72) Inventors: MASASHI MATSUDA, Kariya-city (JP); SATOSHI DOI, Kariya-city (JP)

(21) Appl. No.: 18/912,316

(22) Filed: Oct. 10, 2024

Related U.S. Application Data
(63) Continuation of application No. PCT/JP2023/011175, filed on Mar. 22, 2023.

(30) Foreign Application Priority Data
Apr. 14, 2022 (JP) 2022-067212

(51) Int. Cl. H02K 15/03; H01F 13/00

(52) U.S. Cl. CPC H02K 15/03; H01F 13/003; H02K 2215/00

(57) ABSTRACT

A manufacturing method of a field magnet device includes: an assembling process that includes assembling a plurality of magnets, which are prior to magnetization, to a magnetizer; a first magnetizing process that includes generating a magnetizing magnetic field from the magnetizer and magnetizing all of the magnets arranged in a circular ring form by using the magnetizing magnetic field; and a second magnetizing process that is executed after the first magnetizing process and includes generating a magnetizing magnetic field, which is stronger than the magnetizing magnetic field generated in the first magnetizing process, from the magnetizer, and sequentially magnetizing all of the magnets by using the magnetizing magnetic field generated in the second magnetizing process such that a predetermined number of magnets continuously arranged in a circumferential direction among the magnets are magnetized each time.

### CROSS REFERENCE TO RELATED APPLICATIONS

This application is a continuation application of International Patent Application No. PCT/JP2023/011175 filed on Mar. 22, 2023, which designated the U.S. and claims the benefit of priority from Japanese Patent Application No. 2022-067212 filed on Apr. 14, 2022. The entire disclosures of all of the above applications are incorporated herein by reference.

### TECHNICAL FIELD

The present disclosure relates to a method for manufacturing a field magnet device.

### BACKGROUND

For example, a field magnet device of a rotary electric machine includes a plurality of magnets. The plurality of magnets generate a plurality of magnetic poles having alternating polarities in a circumferential direction. At the time of manufacturing the field magnet device, each of the magnets is magnetized. For example, there has been proposed a method of magnetizing all of the magnets arranged in the circumferential direction in the field magnet device at once.

### SUMMARY

This section provides a general summary of the disclosure, and is not a comprehensive disclosure of its full scope or all of its features.

According to the present disclosure, there is provided a method for manufacturing a field magnet device. The field magnet device includes a plurality of magnets. The plurality of magnets generate a plurality of magnetic poles having alternating polarities in a circumferential direction. The method includes an assembling process, a first magnetizing process and a second magnetizing process. The assembling process includes assembling the plurality of magnets, which are prior to magnetization, to a magnetizer in a state where the plurality of magnets are arranged in a circular ring form. The first magnetizing process includes generating a magnetizing magnetic field from the magnetizer and magnetizing all of the plurality of magnets arranged in the circular ring form by using the magnetizing magnetic field. The second magnetizing process is executed after the first magnetizing process and includes generating a magnetizing magnetic field, which is stronger than the magnetizing magnetic field generated in the first magnetizing process, from the magnetizer, and sequentially magnetizing the plurality of magnets arranged in the circular ring form by using the magnetizing magnetic field generated in the second magnetizing process such that a predetermined number of magnets continuously arranged in the circumferential direction among the plurality of magnets are magnetized each time.

### BRIEF DESCRIPTION OF DRAWINGS

The drawings described herein are for illustrative purposes only of the selected embodiment and not all possible implementations, and are not intended to limit the scope of the present disclosure.

FIG. 1 is a perspective view schematically showing a rotor.

FIG. 2 is a transverse cross-sectional view of the rotor.

FIG. 3 is a diagram showing orientation directions of magnets.

FIG. 4 is a diagram showing the rotor and a magnetizer.

FIG. 5 is a diagram showing a state of a magnetic flux in a case of executing split magnetization.

FIG. 6 is a diagram showing an angular distribution of a magnet surface magnetic flux density.

FIG. 7 is a circuit diagram showing an electrical structure of the magnetizer.

FIG. 8 is a flowchart showing a procedure of a magnetizing process.

FIG. 9 is a diagram showing a structure of a position limiter member at (a) and (b) of FIG. 9.

FIG. 10 is a diagram for describing all-round magnetization at (a) of FIG. 10 and for describing split magnetization at (b) of FIG. 10.

### DETAILED DESCRIPTION

For example, a field magnet device of a rotary electric machine includes a plurality of magnets. The plurality of magnets generate a plurality of magnetic poles having alternating polarities in a circumferential direction. At the time of manufacturing the field magnet device, each of the magnets is magnetized. For example, there has been proposed a method of magnetizing all of the magnets arranged in the circumferential direction in the field magnet device at once.

As the method of magnetizing each of the magnets of the field magnet device, besides the above-described method of magnetizing all of the magnets at once, it is conceivable to divide all of the magnets arranged in the circumferential direction into a plurality of groups, each of which includes some of all of the magnets, and the magnetization is carried out for each of the groups of magnets individually. However, in the case of dividing all of the magnets into the groups and magnetizing each of the groups of magnets individually, when a leaking magnetic flux, which leaks from a magnetizing area that contains the magnets which are current magnetizing subjects, the magnet(s) outside of the magnetizing area may possibly be magnetized in an unintended direction, thereby possibly resulting in generation of a variation in a surface magnetic flux density of each magnet.

A plurality of aspects disclosed in this specification employ various technical measures. The features and effects disclosed in this specification will become clearer with reference to the subsequent detailed description and accompanying drawings.

According to a first aspect of the present disclosure, there is provided a method for manufacturing a field magnet device that includes a plurality of magnets, wherein the plurality of magnets generate a plurality of magnetic poles having alternating polarities in a circumferential direction, the method including:
an assembling process that includes assembling the plurality of magnets, which are prior to magnetization, to a magnetizer in a state where the plurality of magnets are arranged in a circular ring form;
a first magnetizing process that includes generating a magnetizing magnetic field from the magnetizer and magnetizing all of the plurality of magnets arranged in the circular ring form by using the magnetizing magnetic field; and
a second magnetizing process that is executed after the first magnetizing process and includes generating a magnetizing magnetic field, which is stronger than the magnetizing magnetic field generated in the first magnetizing process, from the magnetizer, and sequentially magnetizing the plurality of magnets arranged in the circular ring form by using the magnetizing magnetic field generated in the second magnetizing process such that a predetermined number of magnets continuously arranged in the circumferential direction among the plurality of magnets are magnetized each time.

The field magnet device includes the plurality of magnets. The plurality of magnets generate the plurality of magnetic poles, and each of the plurality of magnetic poles is formed by one or more of the plurality of magnets. In the case of magnetizing each of the plurality of magnets of the field magnet device, all of the magnets are divided into groups each of which includes the predetermined number of magnets, and the predetermined number of magnets are magnetized each time. In this way, simplification of a magnetizing facility is possible. However, in the case, in which the predetermined number of magnets are magnetized each time, a variation in a surface magnetic flux density may possibly be generated at each of the magnets due to a leaking magnetic flux applied to the magnet(s) other than the magnets which are the current magnetizing subjects.

In view of the above point, in the method for manufacturing the field magnet device of the present disclosure, the magnetization is carried out in two stages. Specifically, as the first stage of magnetization, all of the magnets arranged in the circular ring form are magnetized by using the magnetizing magnetic field generated by the magnetizer (the first magnetizing process). Thereafter, as the second stage of magnetization, the magnetizing magnetic field, which is stronger than the magnetizing magnetic field generated in the first stage of magnetization, is generated, and the magnets are sequentially magnetized by using the magnetizing magnetic field generated in the second stage of magnetization such that the predetermined number of magnets continuously arranged in the circumferential direction among all of the magnets arranged in the circular ring form are magnetized each time (the second magnetizing process). In this case, all-round magnetization is carried out by using the magnetizing magnetic field, which is relatively weak, and thereby a counter magnetic flux, which counteracts against the leaking magnetic flux, is generated at each magnet. Furthermore, in the second stage of magnetization, the leaking magnetic flux may be generated by the magnetizing magnetic field, which is relatively strong, thereby possibly influencing the nearby magnet(s) which has the same magnetic polarity as the magnet(s) which is the current magnetizing subject(s). However, the influence of the leaking magnetic flux on the nearby magnet(s) is limited or minimized by the counter magnetic flux of the nearby magnet(s) generated in the first stage of magnetization. Therefore, the variation in the surface magnetic flux density in each magnet is limited. As a result, each of the magnets of the field magnet device can be properly magnetized.

According to a second aspect, there is provided the method for manufacturing the field magnet device according to the first aspect, wherein:
in the first magnetizing process, the magnetizing of the plurality of magnets is carried out by using a magnetic field weaker than a saturation magnetic field, which causes saturation magnetization of the plurality of magnets, as the magnetizing magnetic field generated in the first magnetizing process; and
in the second magnetizing process, the magnetizing of the plurality of magnets is carried out by using the saturation magnetic field as the magnetizing magnetic field generated in the second magnetizing process.

In the first magnetizing process, the magnetization is carried out by using the magnetic field weaker than the saturation magnetization field, and in the second magnetizing process, the magnetization is carried out by using the saturation magnetic field. Therefore, each of the magnets can be magnetically saturated as desired.

According to a third aspect, there is provided the method for manufacturing the field magnet device according to the first or second aspect, wherein:
the magnetizer includes:
   a magnetizing yoke that is configured to oppose the field magnet device;
   a plurality of magnetizing coils that are installed to the magnetizing yoke and are provided to the plurality of magnetic poles, respectively, of the field magnet device;
   an electric power supply that is configured to supply electric power to the plurality of magnetizing coils; and
   a switcher that is configured to switch between:
      a first state in which the electric power for generating the magnetizing magnetic field is supplied from the electric power supply to all of the plurality of magnetizing coils; and
      a second state in which the electric power for generating the magnetizing magnetic field is supplied from the electric power supply to corresponding one or more of the plurality of magnetizing coils which are less than all of the plurality of magnetizing coils;
in the first magnetizing process, the first state is implemented, and the magnetizing is performed on all of the plurality of magnets; and
in the second magnetizing process, the second state is implemented, and the plurality of magnets are sequentially magnetized such that the predetermined number of magnets among the plurality of magnets are magnetized each time.

In the first magnetizing process, the first state, in which the electric power is supplied from the electric power supply to all of the plurality of magnetizing coils of the magnetizer, is implemented, and all of the plurality of magnets are magnetized. In the second magnetizing process, the second state, in which the electric power is supplied from the electric power supply to the corresponding one or more of the plurality of magnetizing coils, is implemented, and the plurality of magnets are sequentially magnetized such that the predetermined number of magnets among the plurality of magnets are magnetized each time. In this case, by distributing the electric power from the electric power supply to each corresponding one of the plurality of magnetizing coils, it is possible to properly carry out the all-round magnetization on the plurality of magnets and the split magnetization (the magnetization of the predetermined number of magnets each time) with the magnetic field stronger than that of the all-round magnetization.

According to a fourth aspect, there is provided the method for manufacturing the field magnet device according to the third aspect, wherein:
the electric power supply includes:
   a capacitor that is configured to supply the electric power for the magnetizing to the plurality of magnetizing coils; and
   an electric charger that is configured to charge the capacitor;
in the first magnetizing process, the capacitor is charged by the electric charger, and the capacitor is then discharged to energize all of the plurality of magnetizing coils simultaneously; and
in the second magnetizing process, each time the predetermined number of magnets serving as a predetermined number of magnetizing subjects are magnetized, the capacitor is charged by the electric charger, and the capacitor is then discharged to energize the corresponding one or more of the plurality of magnetizing coils, which correspond to the predetermined number of magnetizing subjects.

In the all-round magnetization on all of the plurality of magnets, all of the plurality of magnetizing coils are energized simultaneously by discharging the capacitor after charging the capacitor. In contrast, in the split magnetization which magnetizes the predetermined number of magnets each time, the predetermined one or more of the plurality of magnetizing coils, which correspond to the predetermined number of magnetizing subjects (the predetermined number of magnets) set each time of magnetization, are energized by discharging the capacitor after charging the capacitor. This makes it possible to suitably implement the magnetization with the stronger magnetic field, which is stronger than that of the all-round magnetization, in the split magnetization. In other words, while using the common capacitor, the energization of the relatively large number of magnetizing coils with the low electric power and the energization of the relatively small number of magnetizing coils with the high electric power can be suitably implemented. Therefore, the capacity of the capacitor can be reduced in comparison to the case where all of the magnetizing coils are energized with the high electric power, thereby enabling the simplification of the magnetizing facility.

According to a fifth aspect, there is provided the method for manufacturing the field magnet device according to the third aspect, wherein:
the field magnet device includes:
   the plurality of magnets; and
   a magnet holder member which is shaped in a cylindrical tubular form and holds each of the plurality of magnets; and
in the assembling process, in a state where a circumferential position of the magnet holder member relative to the magnetizing yoke is limited by a position limiter member, the plurality of magnets are assembled to the magnetizer.

Since the circumferential position of the magnet holder member relative to the magnetizing yoke is limited by the position limiter member, each of the magnets can be assembled in the proper position relative to the corresponding magnetizing coil. Therefore, at the time of performing the split magnetization, it is possible to appropriately magnetize the corresponding magnets, which are subject to the split magnetization, among all of the plurality of magnets.

According to a sixth aspect, there is provided the method for manufacturing the field magnet device according to the first aspect, wherein a magnet thickness dimension D1, which is a thickness of each of the plurality of magnets measured in a radial direction, and a width dimension D2 of each of the plurality of magnetic poles measured in the circumferential direction satisfy a relationship of D1>D2×½.

In the configuration described above, the magnet thickness dimension D1, which is the thickness of each of the plurality of magnets measured in the radial direction, and the width dimension D2 of each of the plurality of magnetic poles measured in the circumferential direction satisfy the relationship of D1>D2×½. With this configuration, since the magnet thickness dimension D1 is relatively large, the relatively strong magnetizing magnetic field is required at the time of magnetizing the magnets, thereby possibly generating the relatively strong leaking magnetic flux. Furthermore, since the circumferential width dimension D2 of each magnetic pole is relatively small, the pole pitch is reduced, thereby possibly resulting in an increased influence of the leaking magnetic flux. For example, in a rotary electric machine having a large number of magnetic poles or high torque, an inconvenience caused by the leaking magnetic flux may possibly become large. In view of this point, as described above, by carrying out the magnetization in the two stages, which include the all-round magnetization and the split magnetization, the suitable magnetization can be achieved even for the field magnet device of the rotary electric machine having the large number of magnetic poles or the high torque.

According to a seventh aspect, there is provided the method for manufacturing the field magnet device according to the first aspect, wherein each of the plurality of magnets is a polar anisotropic magnet.

In a case where the magnet has the polar anisotropic orientation, there is a greater concern about the variation of the magnetic flux density of the magnet caused by the leaking magnetic flux at the time of executing the split magnetization. With respect to this point, as described above, by carrying out the magnetization in the two stages, which include the all-round magnetization and the split magnetization, the suitable magnetization can be achieved even for the field magnet device that uses the polar anisotropic magnets.

### EMBODIMENT

Hereinafter, an embodiment will be described with reference to the drawings. A rotary electric machine of the present embodiment is used as, for example, an in-vehicle electric device. However, the rotary electric machine of the present disclosure can be widely used for industrial machines, ships, aircrafts, home appliances, OA machines, game machines and the like.

The rotary electric machine of the present embodiment is an outer-rotor surface magnet type multiphase AC motor, which, as is well known, has a rotor (serving as a field magnet device) and a stator (serving as an armature). The rotor and the stator are arranged to radially oppose each other, and the rotor is rotatable about a rotational axis relative to the stator. Although not illustrated in the drawing, the stator is, for example, a stator with a teeth-less structure in which stator windings are assembled at a radially outer side of a stator core (back yoke) shaped in, for example, a cylindrical tubular form. However, the stator may be a stator having a slot-wound structure in which the stator windings are wound around a plurality of slots of the stator core.

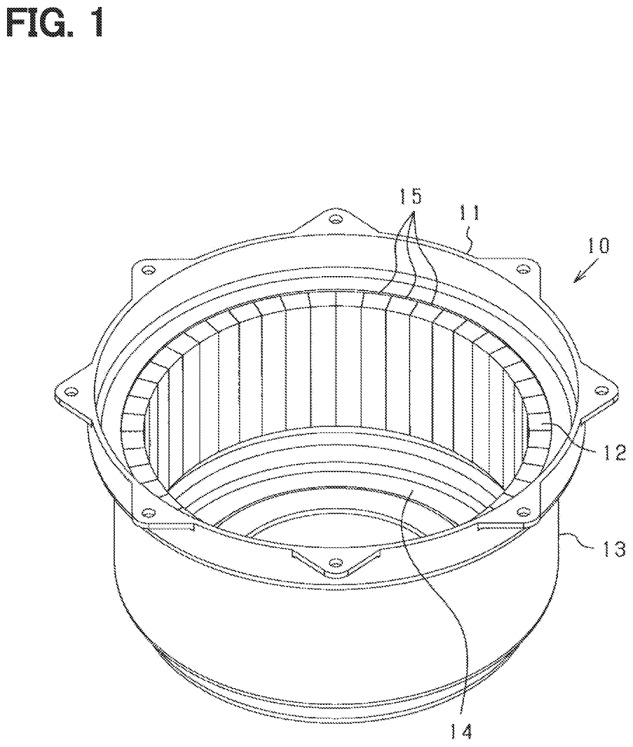

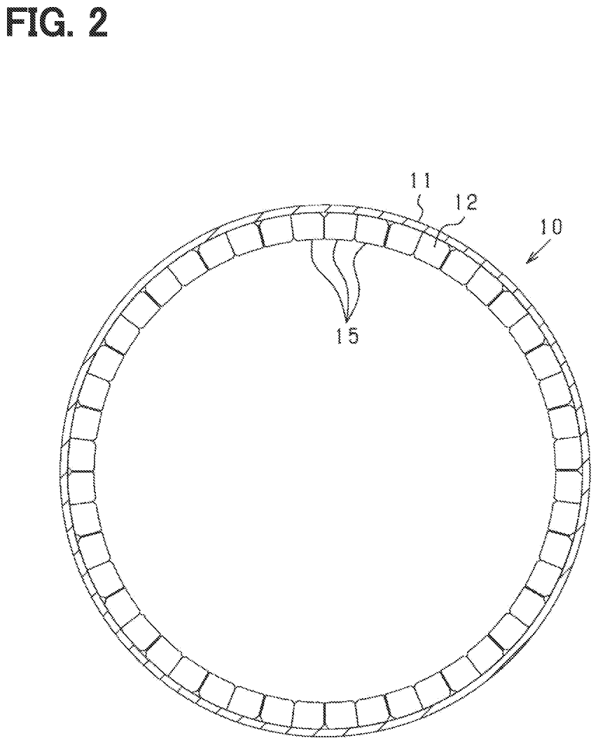

FIG. 1 is a perspective view schematically showing the rotor 10, and FIG. 2 is a transverse cross-sectional view of the rotor 10.

The rotor 10 includes: a rotor carrier 11 that is shaped generally in a cylindrical tubular form; and a magnet unit 12 that is shaped in a ring form and is fixed to the rotor carrier 11. The rotor carrier 11 includes: a tubular portion 13 that is made of, for example, a magnetic material and is shaped in a cylindrical tubular form; and an end plate portion 14 that is placed at one axial end of the tubular portion 13. The magnet unit 12 is fixed to a radially inner side of the tubular portion 13. The other axial end of the rotor carrier 11 is opened. The rotor carrier 11 serves as a magnet holder member.

The magnet unit 12 includes a plurality of magnets 15 which generate a plurality of magnetic poles that have alternating polarities in a circumferential direction of the rotor 10. Therefore, the magnet unit 12 has the plurality of magnetic poles arranged in the circumferential direction. Each of the magnets 15 is, for example, a sintered neodymium magnet with an intrinsic coercive force of 400 [kA/m] or higher and a residual flux density Br of 1.0 [T] or higher.

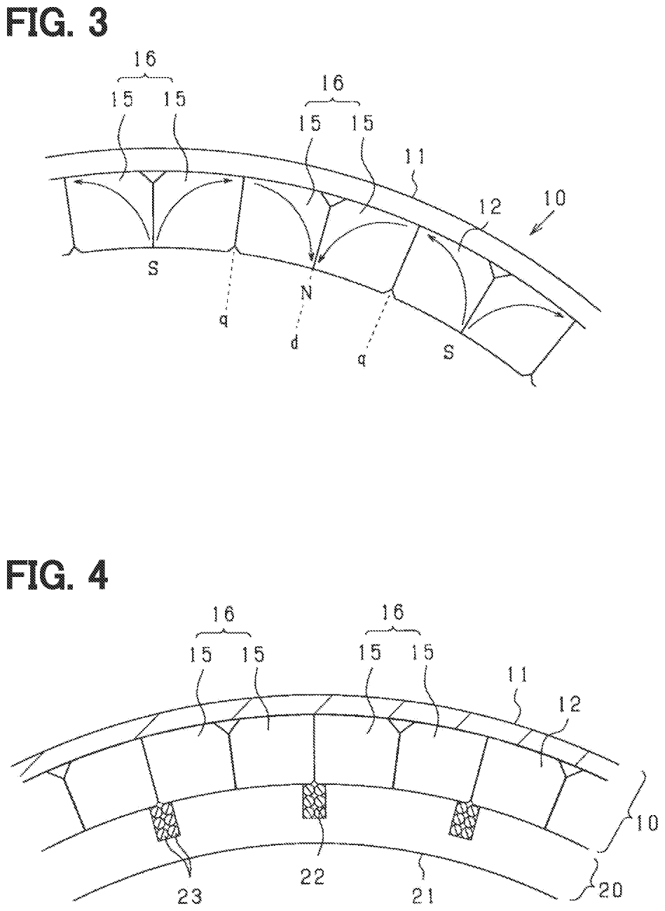

Each of the magnets 15 of the magnet unit 12 is a polar anisotropic permanent magnet (or simply referred to as a polar anisotropic magnet). As shown in FIG. 3, the magnets 15 are formed such that a direction of the easy magnetization axis differs between the d-axis side (a portion adjacent to the d-axis which is the magnetic pole center) and the q-axis side (a portion adjacent to the q-axis which is a magnetic pole boundary). At the d-axis side, the direction of the easy magnetization axis is parallel to the d-axis, and at the q-axis side, the direction of the easy magnetization axis is perpendicular to the q-axis. In this case, a magnet magnetic path, which has an arcuate shape along the direction of the easy magnetization axis, is formed. In short, each magnet 15 is configured such that at the d-axis side (here, the d-axis being the magnetic pole center), the direction of the easy magnetization axis is parallel to the d-axis in comparison to the q-axis side (here, the q-axis being the magnetic pole boundary).

The magnet unit 12 is formed such that each corresponding two of the magnets 15 are provided per magnetic pole, and the magnets 15 are installed such that circumferential side surfaces of each circumferentially adjacent two of the magnets 15 are in contact with each other. In the following description, the magnets 15 per magnetic pole, i.e., the two magnets 15, which are arranged adjacent to each other in the circumferential direction and have the same magnetic polarity, are also collectively referred to as a magnetic pole magnet 16. However, in the magnet unit 12, only one magnet 15 may be provided per magnetic pole.

In the present embodiment, a method for manufacturing the magnet unit 12 has a unique feature, and this method will be described hereinafter.

At the time of manufacturing the magnet unit 12, refined raw materials, such as neodymium, boron and iron, are first melted and alloyed (a melting process). Next, the alloy obtained in the melting process is pulverized into particles, i.e., powder (a pulverizing process). The powder obtained from the pulverizing process is then filled into a molding die and is compression-molded in a magnetic field (a molding process). By this molding process with the molding die, the magnet 15 is molded into a predetermined shape. Furthermore, in this process, the easy magnetization axis is oriented, for example, in the arcuate shape, at the magnet 15 as described above.

After the compression molding, the compact is sintered (a sintering process) and then heat-treated (a heat treatment process). During the heat treatment, the compact is repeatedly heated and cooled several times. Thereafter, machining, such as grinding, and surface treatment are performed on it (a processing process). Then, it is magnetized (a magnetizing process), and thereby the manufacturing of the magnet 15 is completed.

In the magnetizing process, the magnet 15 is magnetized by using a magnetizer 20 that is a manufacturing device. Hereinafter, the magnetizer 20 and the magnetizing process are described in detail. First of all, the magnetizer 20 will be described. FIG. 4 shows: the rotor 10; and the magnetizer 20 assembled to the rotor 10.

The magnetizer 20 is a device that magnetizes the magnets 15 of each pole by using an electromagnet. The magnetizer 20 includes: a magnetizing yoke 21 that is shaped in a circular ring form and has a plurality of slots 22 at a radially outer side thereof; and a plurality of magnetizing coils 23 respectively received in the slots 22. At the magnetizing yoke 21, the number of the slots 22 is the same as the number of the magnetic poles of the rotor 10, and these slots 22 are arranged at the same pitches as those of the magnetic poles of the rotor 10. Each of the magnetizing coils 23 is provided to the corresponding one of the magnetic poles of the rotor 10 and is formed by winding a conductor wire multiple times between corresponding circumferentially adjacent two of the slots 22.

The rotor 10 is positioned on the radially outer side of the magnetizing yoke 21. At this time, the rotor 10 is positioned such that the magnetic pole center (d-axis) of each magnet coincides with a circumferential center between the corresponding two of the slots 22 of the magnetizing yoke 21. Then, a magnetizing magnetic field is generated for each of the magnetic poles of the rotor 10 when an electric current flows through each of the magnetizing coils 23 in response to the energization from an electric power source described later. Each of the magnets 15 is magnetized by this magnetizing magnetic field to form the plurality of magnetic poles that are arranged to have alternating polarities in the circumferential direction at the rotor 10.

Here, as a method of magnetizing each magnet 15 of the magnet unit 12, it is conceivable to have the following magnetizing method. That is, all of the magnets 15 of the rotor 10 are divided into a plurality of groups each of which includes several of the magnets 15 continuously arranged in the circumferential direction, and the groups of magnets 15 are sequentially magnetized with the magnetizer 20. Referring to the magnetic poles, this method is a method that sequentially magnetizes a predetermined number of magnetic poles each time among all of the magnetic poles (the magnetic pole magnets 16) of the rotor 10 by the magnetizer 20. In the following description, there will be described two types of magnetizations. That is, in one type of magnetization, all of the magnets 15 of the magnet unit 12 are simultaneously magnetized by the magnetizer 20. In the other type of magnetization, the groups of magnets 15, each of which includes the several magnets 15, are sequentially magnetized by the magnetizer 20. The one type of magnetization will be referred to as all-round magnetization, and the other type of magnetization will be referred to as split magnetization.

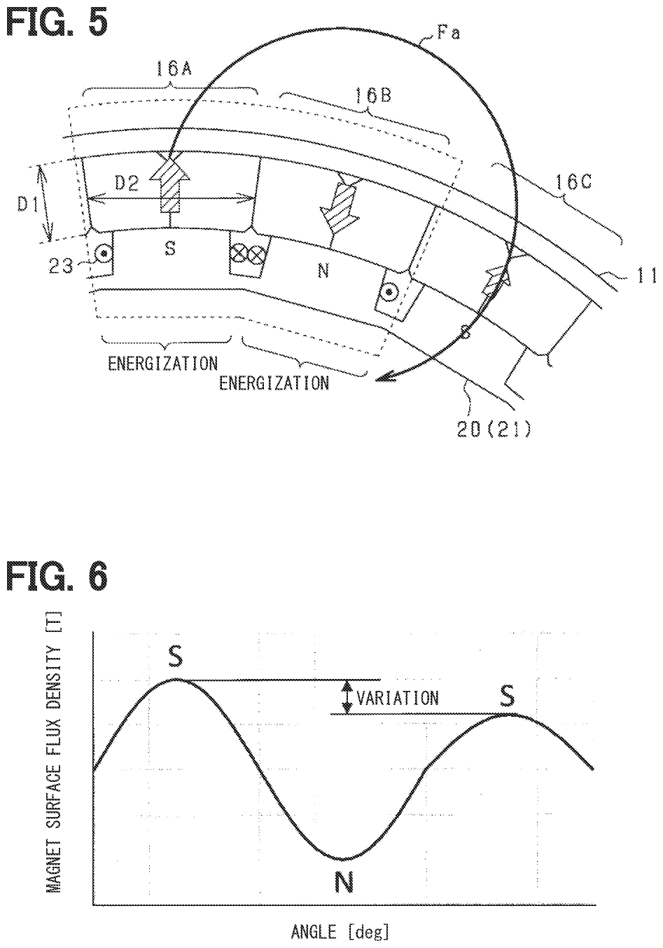

FIG. 5 shows the state at the time of executing the split magnetization. FIG. 5 shows three magnetic pole magnets 16A, 16B, 16C, which form three magnetic poles, respectively. FIG. 5 indicates the state of executing the magnetization of two magnetic pole magnets 16A, 16B, which form two magnetic poles, respectively, and serve as two current magnetizing subjects (i.e., a predetermined number of magnetizing subjects) to be magnetized among the three magnetic pole magnets 16A, 16B, 16C. In FIG. 5, the magnetizer 20 is shown in a different form than in FIG. 4, but the configuration of the magnetizer 20 shown in FIG. 4 and the configuration of the magnetizer 20 shown in FIG. 5 are substantially identical.

In FIG. 5, the S-pole magnetizing coil 23 and the N-pole magnetizing coil 23 are energized to magnetize the two magnetic pole magnets 16A, 16B. As a result, a magnetizing magnetic flux acts on the magnetic pole magnets 16A, 16B, which serve as the current magnetizing subjects, as indicated by arrows in FIG. 5. In this case, by energizing the corresponding respective magnetizing coils 23, a leaking magnetic flux Fa acts on the magnetic pole magnet 16C, which is not the current magnetizing subject, in addition to the magnetizing magnetic flux acting on the magnetic pole magnets 16A, 16B, which are the current magnetizing subjects. Due to the generation of the leaking magnetic flux Fa, a variation is generated among the surface magnetic flux densities of the magnets 15 at the respective magnetic poles, as shown in FIG. 6.

As shown in FIG. 5, it is conceivable that a magnet thickness dimension D1, which is a thickness of each magnet 15 measured in the radial direction, and a width dimension D2 of each magnetic pole measured in the circumferential direction satisfy a relationship of D1>D2×½. The width dimension D2 may be, for example, a width dimension of the magnetic pole magnet 16 measured at a radial center of the magnetic pole magnet 16, or a width dimension of the magnetic pole magnet 16 measured at a radially inner end part of the magnetic pole magnet 16, or a width dimension of the magnetic pole magnet 16 measured at a radially outer end part of the magnetic pole magnet 16. With the configuration described above, it is conceivable that the relatively large magnet thickness dimension D1 requires a strong magnetizing magnetic field at the time of magnetizing the magnets 15, resulting in generation of a strong leaking magnetic flux Fa. Furthermore, since the circumferential width dimension D2 of each magnetic pole is relatively small, the pole pitch is reduced, thereby possibly resulting in an increased influence of the leaking magnetic flux Fa. For example, in a rotary electric machine having a large number of magnetic poles or high torque, an inconvenience caused by the leaking magnetic flux Fa may possibly become large.

In the present embodiment, the magnetization is carried out in two stages at the time of manufacturing the rotor 10. Specifically, as the first stage of magnetization, all of the magnets 15 arranged in the circular ring form are magnetized by using the magnetizing magnetic field generated by the magnetizer 20 (a first magnetizing process). Thereafter, as the second stage of magnetization, the magnetizing magnetic field, which is stronger than the magnetizing magnetic field generated in the first stage of magnetization, is generated, and the magnets 15 are sequentially magnetized by using the magnetic field generated in the second stage of magnetization such that a predetermined number of magnets 15, which are less than all of the magnets 15 and are continuously arranged in the circumferential direction among all of the magnets 15 arranged in the circular ring form, are magnetized each time (a second magnetizing process). Hereinafter, details thereof will be described.

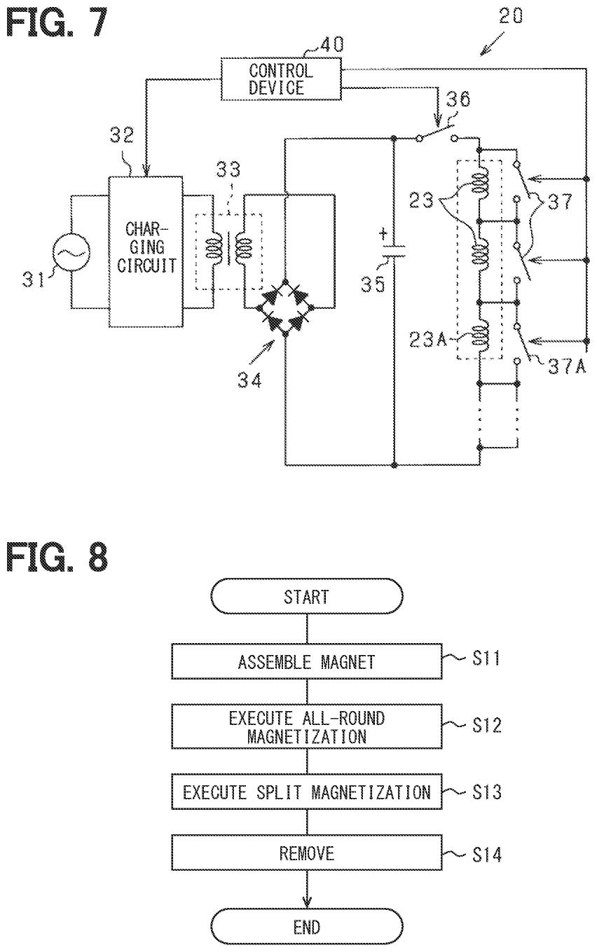

FIG. 7 is a circuit diagram showing an electrical structure of the magnetizer 20. As shown in FIG. 7, the magnetizer 20 includes an AC (Alternating Current) electric power source 31, an electric charger circuit 32, a booster circuit 33, a rectifier circuit 34, a capacitor 35, a primary switch 36, a plurality of secondary switches 37 and a control device (a controller device) 40.

The booster circuit 33 is connected to the AC electric power source 31 through the electric charger circuit 32. The electric charger circuit 32 switches its operational state between a state, in which the AC power is outputted from the AC electric power source 31 to the booster circuit 33, and another state, in which the AC power is not outputted from the AC electric power source 31 to the booster circuit 33. Here, it should be noted that the AC electric power source 31 may be an external electric power source. The rectifier circuit 34 is connected to the booster circuit 33. The booster circuit 33 boosts a voltage of the AC power supplied from the AC electric power source 31 and outputs it to the rectifier circuit 34. The capacitor 35 is connected to the rectifier circuit 34. The rectifier circuit 34 converts the alternating current (AC) received from the booster circuit 33 into a direct current (DC) and charges the capacitor 35. The capacitor 35 is charged with a voltage of, for example, several thousand volts (V).

The plurality of magnetizing coils 23 are connected in series, and the capacitor 35 is connected in parallel to the plurality of magnetizing coils 23. Each corresponding magnetizing coil 23 is energized when the capacitor 35 is discharged. The primary switch 36 is installed in an electrical path between the capacitor 35 and the magnetizing coils 23 to switch between: an open state, in which the switch 36 prevents a flow of the electric current through the electrical path; and a closed state, in which the switch 36 allows the flow of the electric current through the electrical path. A short-circuit path is provided to each of two opposite ends of each magnetizing coil 23, and a corresponding one of secondary switches 37 is installed in each of the short-circuit paths.

In the present embodiment, the capacitor 35 serves as an electric power supply that is configured to supply the electric power to the respective magnetizing coils 23. Furthermore, the AC electric power source 31, the electric charger circuit 32, the booster circuit 33 and the rectifier circuit 34 serve as an electric charger that is configured to charge the capacitor 35.

The control device 40 operates the electric charger circuit 32 to switch an operational state between: the state, in which the AC power is outputted from the AC electric power source 31 to the booster circuit 33; and the state, in which the AC power is not outputted from the AC electric power source 31 to the booster circuit 33. In this case, when the AC power is output from the AC electric power source 31 to the booster circuit 33, the capacitor 35 is charged. Furthermore, the control device 40 also controls on/off of each of the switches 36, 37. In this case, the electric current is supplied from the capacitor 35 to predetermined one or more of the plurality of magnetizing coils 23, which are less than all of the plurality of magnetizing coils 23, by maintaining the turning on of the primary switch 36 and turning off of at least one of the secondary switches 37.

In the present embodiment, at the time of magnetizing the magnet unit 12, it is possible to execute the all-round magnetization, in which all of the magnets 15 are simultaneously magnetized by placing all of the magnetizing coils 23 in the energized state, and the split magnetization, in which the magnets 15 are sequentially magnetized such that the predetermined number of magnets 15 among all of the magnets 15 are magnetized each time. The on/off state of each of the switches 36 and 37 is controlled according to which specific magnets 15 are magnetized among all the magnets 15.

In this case, at the time of executing the all-round magnetization, the control device 40 turns on the primary switch 36 and turns off all of the secondary switches 37. Therefore, all of the magnetizing coils 23 are energized (corresponding to a first state).

In contrast, at the time of executing the split magnetization, the control device 40 turns on the primary switch 36 and turns off one or more (but not all) of the secondary switches 37. Therefore, corresponding one or more of the magnetizing coils 23, which are less than all of the magnetizing coils 23, are energized (corresponding to a second state). Specifically, for example, in a case where only the magnetizing coil 23A is energized among all of the magnetizing coils 23 shown in FIG. 7, the primary switch 36 is turned on, and only the secondary switch 37A, which corresponds to the magnetizing coil 23A, is turned off, and the rest of the secondary switches 37 are all turned on. In this way, only the magnetizing coil 23A is energized. The control device 40 serves as a switcher that is configured to switch between the first state and the second state.

In the present embodiment, all of the magnetizing coils 23 are grouped such that each corresponding circumferentially adjacent two of the magnetizing coils 23 are set as a group of magnetizing coils 23, and the groups of magnetizing coils 23 are sequentially energized to magnetize the group of magnets 15 sequentially. In the structure shown in FIG. 7, the secondary switch 37 may be provided for each two of the magnetizing coils 23. The number of the magnetizing coils 23 to be subject per magnetization in the split magnetization is at least one and may be half of the total number of the magnetizing coils 23.

Here, in the case of executing the all-round magnetization, the electric power charged in the capacitor 35 is supplied to all of the magnetizing coils 23. In contrast, in the case of executing the split magnetization, the electric power charged in the capacitor 35 is supplied only to the predetermined one or more of the magnetizing coils 23, which are less than all of the magnetizing coils 23, each time. Therefore, in the case of executing the all-round magnetization, the applied voltage for each magnetizing coil 23 becomes relatively low, and each magnet 15 is magnetized in a relatively weak magnetic field. In contrast, in the case of executing the split magnetization, the applied voltage for each magnetizing coil 23 becomes relatively high, and each magnet 15 is magnetized in a relatively strong magnetic field.

Hereinafter, the magnetizing process including the all-round magnetization and the split magnetization will be described. FIG. 8 is a flowchart showing a detailed procedure of the magnetizing process.

At the time of magnetizing the respective magnets 15, the rotor 10, in which the magnets 15 are not yet magnetized, is installed to the magnetizer 20 (step S11). Thereby, the magnets 15, which are prior to the magnetization, are assembled to the magnetizer 20 in the state where the magnets 15 are arranged in the circular ring form. Each of the magnets 15 is a magnet whose easy magnetization axis is already oriented as described above. At this time, each magnet 15 is positioned so that the q-axis is opposed to the corresponding slot 22. Here, step S11 serves as an assembling process.

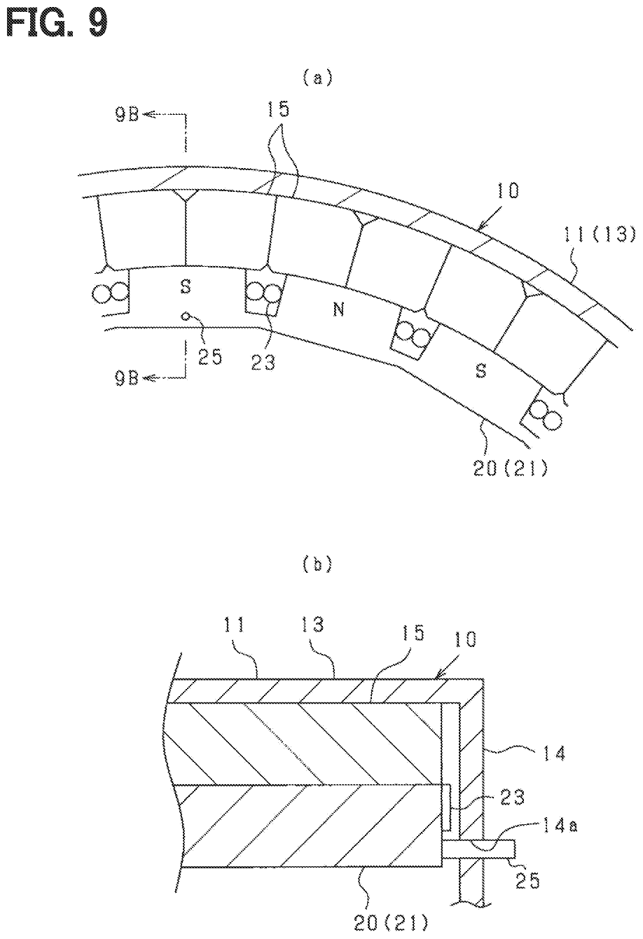

In this assembling process, each of the magnets 15 may be assembled to the magnetizer 20 in a state where a circumferential position of the rotor carrier 11 relative to the magnetizing yoke 21 is limited. FIG. 9 shows a specific configuration for limiting the position of the rotor carrier 11. Here, (a) of FIG. 9 shows a transverse cross-section of the rotor 10 and the magnetizer 20, and (b) of FIG. 9 shows a cross-section taken along line 9B-9B in (a) of FIG. 9.

As shown in (a) and (b) of FIG. 9, the magnetizing yoke 21 is positioned on an opposite side of the magnets 15 of the rotor 10, which is opposite to the rotor carrier 11, (i.e., on the radially inner side of the magnets 15 of the rotor 10). In this state, an axial end portion of the magnetizing yoke 21 and the end plate portion 14 of the rotary carrier 11 are opposed to each other. Furthermore, the magnetizing yoke 21 has an engaging portion 25 which is shaped in a columnar form extending in the axial direction. When the engaging portion 25 is inserted into a positioning hole 14a formed at the end plate portion 14 of the rotor carrier 11, the circumferential position of the rotor carrier 11 relative to the magnetizing yoke 21 is limited. The engaging portion 25 serves as a position limiter member.

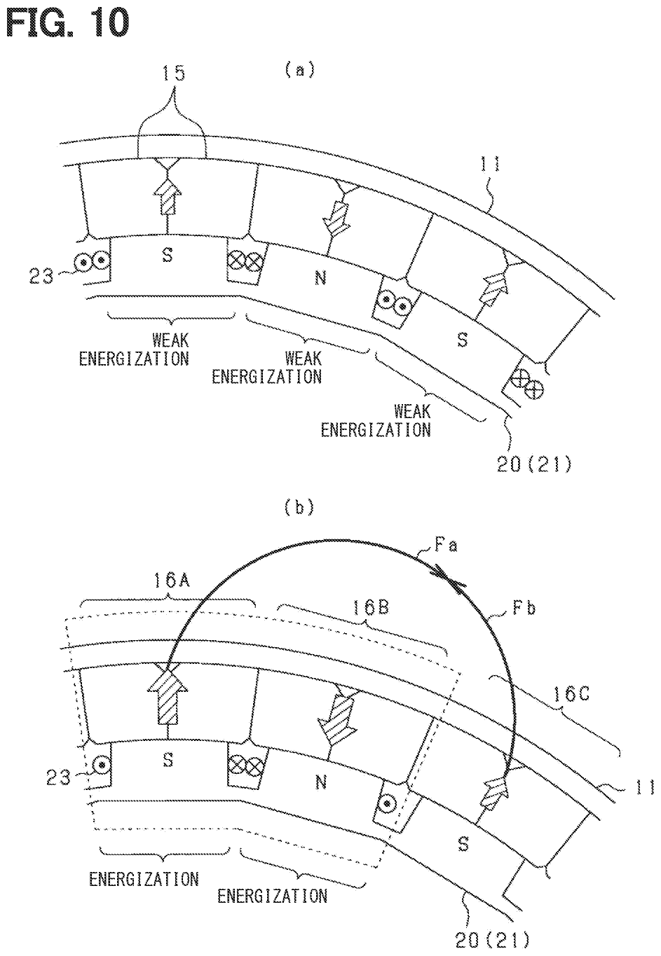

Next, as the first stage of magnetization, the all-round magnetization of the rotor 10 is executed (step S12). Here, (a) of FIG. 10 is a diagram for describing the all-round magnetization. As shown in (a) of FIG. 10, in the all-round magnetization, a relatively weak magnetizing magnetic field is generated through supply of relatively weak electric power to all of the magnetizing coils 23 of the magnetizer 20, and all of the magnets 15 arranged in the circular ring form are magnetized by using the relatively weak magnetizing magnetic field. Here, step S12 serves as the first magnetizing process. In this all-round magnetization, the capacitor 35 is charged in response to the output of the AC power from the AC electric power source 31, and all of the magnetizing coils 23 are energized simultaneously by discharging the capacitor 35. Thereby, the all-round magnetization is executed by the relatively weak magnetizing magnetic field. At this time, the magnetization of each magnet 15 is carried out by using the magnetic field weaker than the saturation magnetic field that causes saturation magnetization of the magnet 15.

Next, as the second stage of magnetization, the split magnetization of the rotor 10 is executed (step S13). Here, (b) of FIG. 10 is a diagram for describing the split magnetization. As shown in (b) of FIG. 10, in the split magnetization, the magnetic pole magnets 16A, 16B, which form the two magnetic poles, respectively, serve as the current magnetizing subjects per magnetization, and relatively strong magnetizing magnetic field is generated through the energization of the corresponding two magnetizing coils 23, thereby magnetizing each of the magnetic pole magnets 16A, 16B. Furthermore, all of the magnets 15 (the magnetic pole magnets 16) arranged in the circular ring form are sequentially magnetized such that the predetermined number of magnets 15 (a predetermined number of the magnetic pole magnets 16) continuously arranged in the circumferential direction among all of the magnets 15 (all of the magnetic pole magnets 16) are magnetized each time. Here, step S13 serves as the second magnetizing process.

In this case, every time the split magnetization is carried out for each corresponding two magnetic poles, the capacitor 35 is charged in response to the output of the AC power from the AC electric power source 31, and the corresponding two magnetizing coils 23, which correspond to the magnets 15 corresponding to the two magnetic poles, are energized by discharging the capacitor 35. Thereby, the split magnetization is executed by the relatively strong magnetizing magnetic field. At this time, the magnetization is carried out by using the saturation magnetic field. Here, the magnetic field, which magnetizes the magnet 15 at the magnetization ratio of 100%, is defined as the saturation magnetization field.

In the split magnetization shown at (b) of FIG. 10, even when the leaking magnetic flux Fa is generated in response to the generation of the relatively strong magnetizing magnetic field, the influence of the leaking magnetic flux Fa is limited by a counter magnetic flux Fb of each magnet 15 which is generated by the previous all-round magnetization. In this case, for example, a decrease in the surface magnetic flux density caused by the leaking magnetic flux Fa is limited at the magnetic pole magnet 16C of the same magnetic polarity which is closest to the magnetic pole magnet 16A of the S-pole in the circumferential direction. In other words, the susceptible magnets 15, which are disadvantageously influenced by the generated leaking magnetic flux Fa, are the magnets 15, which have the same polarity as and are spaced from the originating magnets 15 generating the leaking magnetic flux Fa by the one magnetic pole in the circumferential direction, and the disadvantageous influence on the susceptible magnet 15 is eliminated or minimized. Therefore, the variation in the surface magnetic flux density in each magnet 15 is limited. The inventors of the present application have confirmed that the variation in the surface magnetic flux density is limited and becomes equal to or less than 25%.

After the completion of the magnetization carried out in the two stages, the rotor 10 is removed from the magnetizer 20 (step S14). Thereby, the magnetizing process ends.

The embodiment described above can achieve the following advantages.

At the time of magnetizing the magnets 15 of the rotor 10, the variation in the surface magnetic flux density is limited in each magnet 15 by implementing the all-round magnetization and the split magnetization as described above. As a result, each of the magnets 15 in the rotor 10 can be properly magnetized. Furthermore, by limiting the variation of the surface magnetic flux density in each magnet 15, it is possible to output the high torque from the rotary electric machine, and it is possible to limit the vibration and the noise caused by the variation of the surface magnetic flux density.

In the all-round magnetization (the first magnetizing process), the magnetization is carried out by using the magnetic field weaker than the saturation magnetization field, and in the split magnetization (the second magnetizing process), the magnetization is carried out by using the saturation magnetic field. Therefore, each of the magnets 15 can be magnetically saturated as desired.

In the all-round magnetization, the first state, in which the electric power is supplied from the electric power supply to all of the magnetizing coils 23 of the magnetizer 20, is implemented, and all of the magnets 15 are magnetized. In the split magnetization, the second state, in which the electric power is supplied from the electric power supply to the corresponding one or more of the magnetizing coils 23 that are less than all of the magnetizing coils 23, is implemented, and the magnets 15 are sequentially magnetized such that the predetermined number of magnets 15 among all of the magnets 15 are magnetized each time. In this case, by distributing the electric power from the electric power supply to each corresponding one of the magnetizing coils 23, it is possible to properly carry out the all-round magnetization on all of the magnets 15 and the split magnetization (the magnetization of the predetermined number of magnets 15 each time) with the magnetic field stronger that of the all-round magnetization.

In the all-round magnetization on all of the magnets 15, all of the magnetizing coils 23 are energized simultaneously by discharging the capacitor 35 after charging the capacitor 35. In contrast, in the split magnetization which magnetizes the predetermined number of magnets 15 each time, the predetermined one or more of the magnetizing coils 23, which correspond to the predetermined number of magnetizing subjects (i.e., the predetermined number of magnets 15) set each time of magnetization, are energized by discharging the capacitor 35 after charging the capacitor 35. This makes it possible to suitably implement the magnetization with the stronger magnetic field, which is stronger than that of the all-round magnetization, in the split magnetization. In other words, while using the common capacitor 35, the energization of the relatively large number of magnetizing coils 23 with the low electric power and the energization of the relatively small number of magnetizing coils 23 with the high electric power can be suitably implemented. Therefore, the capacity of the capacitor can be reduced in comparison to the case where all of the magnetizing coils 23 are energized with the high electric power, thereby enabling the simplification of the magnetizing facility.

Since the circumferential position of the rotor carrier 11 relative to the magnetizing yoke 21 is limited by the engaging portion 25 serving as the position limiter member, each of the magnets 15 can be assembled in the proper position relative to the corresponding magnetizing coil 23. Therefore, at the time of performing the split magnetization, it is possible to appropriately magnetize the corresponding magnets 15, which are subject to the split magnetization, among all of the magnets 15.

In the configuration described above, the magnet thickness dimension D1, which is the thickness of each magnet 15 measured in the radial direction, and the width dimension D2 of each magnetic pole measured in the circumferential direction, satisfy the relationship of D1>D2×½. With this configuration, the influence of the leaking magnetic flux Fa may possibly be increased. For example, in a rotary electric machine having a large number of magnetic poles or high torque, an inconvenience caused by the leaking magnetic flux Fa may possibly become large. In view of this point, as described above, by carrying out the magnetization in the two stages, which include the all-round magnetization and the split magnetization, the suitable magnetization can be achieved even for the rotor 10 of the rotary electric machine having the large number of magnetic poles or the high torque.

In a case where the magnet 15 has the polar anisotropic orientation, there is a greater concern about the variation of the magnetic flux density of the magnet 15 caused by the leaking magnetic flux Fa at the time of executing the split magnetization. With respect to this point, as described above, by carrying out the magnetization in the two stages, which include the all-round magnetization and the split magnetization, the suitable magnetization can be achieved even for the rotor 10 that uses the polar anisotropic magnets as the magnets 15.

### (Modifications)

In the embodiment described above, the predetermined number of magnets 15, which correspond to the two magnetic poles, are magnetized simultaneously each time in the split magnetization. This may be modified such that in the split magnetization, a predetermined number of magnets 15, which correspond to only one magnetic pole, are magnetized simultaneously each time, or a predetermined number of magnets 15, which correspond to three or more magnetic poles, are magnetized simultaneously each time.

In the embodiment described above, the magnet unit 12 has the configuration in which the magnets 15 are divided into the groups such that each of the magnetic poles is formed by the group of magnets 15. This configuration may be modified such that each of the magnets is provided to form a plurality of magnetic poles, or a single magnet, which is shaped in a circular ring form, is provided to form the plurality of magnetic poles. Furthermore, the magnets 15 are not limited to the magnets 15 that form the magnet magnetic path that has the arcuate shape. For example, the magnets 15 may be magnets that form a magnet magnetic path that linearly extends in the radial direction.

In the embodiment described above, the surface magnet type rotor is used as the rotor 10. Alternatively, an interior magnet type rotor may be used as the rotor 10.

In the embodiment described above, the rotary electric machine is the outer rotor type. Alternatively, the rotary electric machine may be an inner rotor type. In the inner rotor type rotary electric machine, the stator is placed radially outside, and the rotor is placed radially inside.

In place of the rotary electric machine which includes the rotor serving as the field magnet device and the stator serving as the armature, there may be used a rotary electric machine which includes a rotor serving as an armature and a stator serving as a field magnet device.

The disclosure in this specification is not limited to the illustrated embodiments. The disclosure encompasses the illustrated embodiments and variations, which are conceivable by those skilled in the art based on the illustrated embodiment(s). For example, the disclosure is not limited to the combination of the components and/or elements indicated in the embodiments. Then disclosure can be implemented in a variety of combinations. The disclosure may have additional parts that can be added to the embodiment(s). The disclosure includes variations, in which some of the components and/or elements of the embodiment(s) is/are omitted. The disclosure encompasses the replacement or combination of the components and/or elements between one of the embodiments and another one of the embodiments. The disclosed technical scope is not limited to the technical scope described in the embodiment(s). Some disclosed technical scope should include the technical scope indicated by the statement of claim(s) and all of equivalents to the technical scope indicated by the statement of claim(s).

Although the present disclosure has been described with reference to the embodiments and the modifications, it is understood that the present disclosure is not limited to the embodiments and the modifications and structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A method for manufacturing a field magnet device that includes a plurality of magnets, wherein the plurality of magnets generate a plurality of magnetic poles having alternating polarities in a circumferential direction, the method comprising:
an assembling process that includes assembling the plurality of magnets, which are prior to magnetization, to a magnetizer in a state where the plurality of magnets are arranged in a circular ring form;
a first magnetizing process that includes generating a magnetizing magnetic field from the magnetizer and magnetizing all of the plurality of magnets arranged in the circular ring form by using the magnetizing magnetic field; and
a second magnetizing process that is executed after the first magnetizing process and includes generating a magnetizing magnetic field, which is stronger than the magnetizing magnetic field generated in the first magnetizing process, from the magnetizer, and sequentially magnetizing the plurality of magnets arranged in the circular ring form by using the magnetizing magnetic field generated in the second magnetizing process such that a predetermined number of magnets continuously arranged in the circumferential direction among the plurality of magnets are magnetized each time.

2. The method for manufacturing the field magnet device according to claim 1, wherein:
in the first magnetizing process, the magnetizing of the plurality of magnets is carried out by using a magnetic field weaker than a saturation magnetic field, which causes saturation magnetization of the plurality of magnets, as the magnetizing magnetic field generated in the first magnetizing process; and
in the second magnetizing process, the magnetizing of the plurality of magnets is carried out by using the saturation magnetic field as the magnetizing magnetic field generated in the second magnetizing process.

3. The method for manufacturing the field magnet device according to claim 1, wherein:
the magnetizer includes:
a magnetizing yoke that is configured to oppose the field magnet device;
a plurality of magnetizing coils that are installed to the magnetizing yoke and are provided to the plurality of magnetic poles, respectively, of the field magnet device;
an electric power supply that is configured to supply electric power to the plurality of magnetizing coils; and
a switcher that is configured to switch between:
a first state in which the electric power for generating the magnetizing magnetic field is supplied from the electric power supply to all of the plurality of magnetizing coils; and
a second state in which the electric power for generating the magnetizing magnetic field is supplied from the electric power supply to corresponding one or more of the plurality of magnetizing coils which are less than all of the plurality of magnetizing coils;
in the first magnetizing process, the first state is implemented, and the magnetizing is performed on all of the plurality of magnets; and
in the second magnetizing process, the second state is implemented, and the plurality of magnets are sequentially magnetized such that the predetermined number of magnets among the plurality of magnets are magnetized each time.

4. The method for manufacturing the field magnet device according to claim 3, wherein:
the electric power supply includes:
a capacitor that is configured to supply the electric power for the magnetizing to the plurality of magnetizing coils; and
an electric charger that is configured to charge the capacitor;
in the first magnetizing process, the capacitor is charged by the electric charger, and the capacitor is then discharged to energize all of the plurality of magnetizing coils simultaneously; and
in the second magnetizing process, each time the predetermined number of magnets serving as a predetermined number of magnetizing subjects are magnetized, the capacitor is charged by the electric charger, and the capacitor is then discharged to energize the corresponding one or more of the plurality of magnetizing coils, which correspond to the predetermined number of magnetizing subjects.

5. The method for manufacturing the field magnet device according to claim 3, wherein:
the field magnet device includes:
the plurality of magnets; and
a magnet holder member which is shaped in a cylindrical tubular form and holds each of the plurality of magnets; and
in the assembling process, in a state where a circumferential position of the magnet holder member relative to the magnetizing yoke is limited by a position limiter member, the plurality of magnets are assembled to the magnetizer.

6. The method for manufacturing the field magnet device according to claim 1, wherein a magnet thickness dimension D1, which is a thickness of each of the plurality of magnets measured in a radial direction, and a width dimension D2 of each of the plurality of magnetic poles measured in the circumferential direction satisfy a relationship of D1>D2×½.

7. The method for manufacturing the field magnet device according to claim 1, wherein each of the plurality of magnets is a polar anisotropic magnet.
